(19) United States
(12) Patent Application Publication
(10) Pub. No.: US 2023/0012247 A1
(43) Pub. Date: Jan. 12, 2023

(54) CUSTOM ENDODONTIC DRILL GUIDE AND METHOD, SYSTEM, AND COMPUTER READABLE STORAGE MEDIA FOR PRODUCING A CUSTOM ENDODONTIC DRILL GUIDE

(71) Applicant: DENTSPLY SIRONA INC., YORK, PA (US)

(72) Inventors: Vincent SHOTTON, Broken Arrow, OK (US); Kevin WILKINSON, Bixby, OK (US)

(73) Assignee: DENTSPLY SIRONA INC., YORK, PA (US)

(21) Appl. No.: 17/779,616

(22) PCT Filed: Dec. 17, 2020
(86) PCT No.: PCT/US2020/065466

§ 371 Date: May 25, 2022

Related U.S. Application Data
(60) Provisional application No. 62/948,916, filed on Dec. 17, 2019.

(51) Int. Cl. A61C 1/08; A61C 5/40

(52) U.S. Cl. CPC A61C 1/082; A61C 5/40

(57) ABSTRACT

A custom drill guide and a method, system, and computer readable media for determining a number and location of canals in the tooth in order to create a custom drill guide to match the anatomy for proper orientation of high speed burs and files for cleaning/shaping. By knowing where the canals are located within the tooth, a relatively small access opening may be created, the small access opening provides for a strong crown during the restoration process.

### CROSS REFERENCE TO RELATED APPLICATIONS

This application is a non-provisional patent application of U.S. Provisional Patent Application No. 62/948,916 which is hereby incorporated by reference in its entirety.

### FIELD OF THE INVENTION

The present invention relates generally to endodontic drill guides and more specifically it relates to a method, a system and computer readable storage media for creating a drill guide for the purpose of providing reduced access openings while providing direction in establishing canal patency within an endodontically treated tooth. The invention also relates to the drill guide and the design of accessories used with the drill guide.

### BACKGROUND OF THE INVENTION

In an Endodontic Root Canal Procedure, once a clinician has determined a tooth requires root canal therapy, the clinician may begin a process of using high speed burs usually driven by air rotating at approximately >2000 RPM to perform an access opening on the tooth. The purpose of creating an access opening in the tooth may be to provide a sufficient opening and pathway (typically straight line access) for the clinician to shape, clean, and obturate (fill/seal) the root canal in order to remove and prevent bacteria from remaining in the root canals of the tooth.

Studies have shown that by creating a smaller access opening of the tooth, the strength of the tooth may be enhanced. The publication by Allen et Al. (Stress distribution in a tooth treated through minimally invasive access compared to one treated through traditional access: A finite element analysis study, J Conserv Dent. 2018 September-October; 21(5): 505-509.) compared a minimally invasive access with composite filling, a minimally invasive access with composite filling and crown, and traditional access with composite filling and crown. Herein a minimally invasive access with composite filling significantly reduced the stress (6.98 MPa) as compared to a minimally invasive access with composite filling and crown (11.79 MPa) and traditional access with composite filling and crown (16.81 MPa) when applying a 100 N occlusal load.

The publication by Zhang et. Al (The Effect of Endodontic Access Cavities on Fracture Resistance of First Maxillary Molar Using the Extended Finite Element Method, J Endod. 2019 March; 45(3):316-321.) shows that the fracture resistance of an endodontically treated tooth may be increased by preparing the conservative endodontic cavity. In the cervical region, larger stress concentration areas were found in the modified endodontic cavity and the traditional endodontic cavity compared with the natural tooth and the conservative endodontic cavity.

According to the American Academy of Endodontics (Endodontics: Colleagues for Excellence: Access Opening and Canal Location: Spring 2010), the number of root canal orifices in a particular tooth may not be known prior to the commencement of treatment. “Although radiographs are helpful and can sometimes indicate the number of roots, the averages have been enumerated the number or position of the root canal orifices cannot be identified.” (Page 4) The number of orifices and location of orifices may be based on training of the clinician including the Law of Symmetry 1, Law of Symmetry 2, Law of Color Change, Law of Orifice Location 1, and Law of Orifice Location 2 (Pages 4-5).

Some prior art have shown a process of digitally scanning the anatomy of a tooth/teeth, converting the digital scan to a file format that can be used to create a drill guide, creating the drill guide, using the drill guide to properly orientate the drill relative to the anatomy of the patient. Most of these prior art have been used for creating drill guides for the placement of Dental Implants as well as Restorations.

U.S. Pat. No. 9,138,299 specifically discusses using digital scans for the purpose of endodontics in being able to take a scanned image of a tooth to help the clinician identify how many canals there are and where they are located as well as having the software create of the access cavity. Furthermore, it discusses being able to create a custom made jig based on the desired access cavity to be created. The limitation of this invention is that it does not discuss nor provide how the jig is designed/created, how it is affixed to the patient, and how it can be used in conjunction with high speed burs for creating access or in conjunction with handfiles for creating canal patency. Furthermore, it specifies enforcing straight line access to the canals of the tooth but does not disclose how this is performed in relationship to the anatomy of the tooth when the clinician is performing the procedure.

U.S. Patent Application 2013/0171580 discusses the process for designing a drill guide for creating access of a tooth. This application is deficient in how the fixture design is produced to allow high speed burs in creating access openings. Furthermore, the application does not disclose how the handfiles may be placed in the tooth in order to create patency of the root canals.

### BRIEF SUMMARY OF THE INVENTION

The invention discloses a method, system, and computer readable media for ensuring that not only does a dental practitioner know how many canals are in the tooth but also their location relative to the anatomy such that a drill guide may be created to match the anatomy for proper orientation of the high speed burs and files for cleaning/shaping. The benefit of this process may be that by knowing where the canals are located within the tooth, a relatively small access opening may be achieved which provides for a strong crown during the restoration process; and by knowing where the canals are located within the tooth, a duration of endodontic procedures and probability of missing canals may be reduced.

Furthermore, the disclosure discloses how a drill guide may be created for providing a minimal access opening for the tooth as well as how the drill guide may be used by the dental practitioner/clinician when handfiling in order to establish canal patency.

In an aspect herein the present invention may provide a method for creating a virtual drill guide for manufacturing a physical drill guide, said method comprising: obtaining a digital 3D representation of one or more physical teeth; obtaining a location of one or more canals in the digital 3D representation; placing a virtual dental dam clamp in the digital 3D representation based on a desired location and/or orientation of a corresponding physical dental dam clamp; placing one or more virtual burs in the digital 3D representation based on the obtained location of the one or more canals; creating a virtual drill guide based on (i) properties of the one or more placed virtual burs, (ii) properties of the virtual dental dam clamp and (iii) anatomies of one or more virtual teeth; wherein the virtual drill guide is designed such that the physical drill guide to be manufactured based on the virtual drill guide includes one or more physical holes based on the location of the placed virtual burs, and such that the one or more physical holes are configured to receive physical burs at a predetermined angle and position in order (i) allow the creation of an access opening to one or more physical canals in one or more physical teeth and (ii) to provide direction in the establishment of canal patency in the one or more physical teeth.

In another aspect herein, the method may further comprise one or more combinations of the following steps (i) manufacturing the physical drill guide based on the virtual drill guide, (ii) placing metal inserts in the one or more physical holes and creating an access opening on the one or more physical teeth using a bur placed inside the metal insert of the physical drill guide, (iii) placing a handfile sleeve into the metal insert until it makes contact with a crown of the one or more physical teeth and establishing canal patency in the one or more physical teeth using a handfile, (iv) wherein the properties of the one or more placed virtual burs and the properties of the dental dam clamp are selected from one or more properties including shape, size, orientation, and position, (v) wherein one or more virtual teeth are segmented from the digital 3D representation to allow for isolated designing of the virtual drill guide, (vi) wherein the one or more virtual burs are placed by rotating and translating them such that a cutting end of the one or more virtual burs are is placed at a canal orifice, (vii) wherein the virtual drill guide is designed to be seated on a single tooth or a plurality of adjacent teeth, (viii) wherein the virtual drill guide is automatically designed, (ix) wherein the virtual drill guide is designed using at least input from a user, (x) wherein the virtual drill guide is designed to include a channel for receiving a light source, (xi) wherein the virtual drill guide is designed to include a connector for connection to a suction system, (xii) wherein virtual drill guide is designed to accommodate a plurality of virtual dental dam clamps.

In an aspect herein, the present invention may provide a method for creating a physical drill guide for endodontic use, said method comprising: obtaining a digital 3D representation of one or more physical teeth; obtaining a location of one or more canals in the digital 3D representation; placing a virtual dental dam clamp in the digital 3D representation based on a desired location and/or orientation of a corresponding physical dental dam clamp; placing one or more virtual burs in the digital 3D representation based on the obtained location of the one or more canals; creating a virtual drill guide based on (i) properties of the one or more placed virtual burs, (ii) properties of the virtual dental dam clamp and (iii) anatomies of one or more virtual teeth; fabricating the physical drill guide using the virtual drill guide.

In still another aspect herein, the present invention may provide a physical drill guide comprising: one or more holes each beginning at a first surface and running through a body of the physical drill guide to a second surface opposite the first surface; and wherein the drill guide is dimensioned to accommodate one or more physical burs, one or more dental dam clamps and to fit on one or more teeth; wherein the dimensions of the one or more holes are configured to receive the physical burs at a predetermined angle and position in order (i) allow the creation of an access opening to one or more physical canals in one or more physical teeth and (ii) to provide direction in the establishment of canal patency in the one or more physical teeth.

In a further aspect herein, the present invention may provide a non-transitory computer-readable storage medium storing a program which, when executed by a computer system, causes the computer system to perform a procedure comprising: comprising: obtaining a digital 3D representation of one or more physical teeth; obtaining a location of one or more canals in the digital 3D representation; placing one or more virtual burs in the digital 3D representation based on the obtained location of the one or more canals; creating a virtual drill guide based on (i) properties of the one or more placed virtual burs, (ii) properties of a virtual dental dam clamp and (iii) anatomies of one or more virtual teeth; and designing the virtual drill guide such that the physical drill guide to be manufactured based on the virtual drill guide includes one or more physical holes based on the location of the placed virtual burs, and such that the one or more physical holes are configured to receive physical burs at a predetermined angle and position in order (i) allow the creation of an access opening to one or more physical canals in one or more physical teeth and (ii) to provide direction in the establishment of canal patency in the one or more physical teeth.

In yet another aspect herein, the present invention may provide a system for creating a virtual drill guide for manufacturing a physical drill guide, said system comprising a processor configured to: obtain a digital 3D representation of one or more physical teeth; obtain a location of one or more canals in the digital 3D representation; place a virtual dental dam clamp in the digital 3D representation based on a desired location and/or orientation of a corresponding physical dental dam clamp; place one or more virtual burs in the digital 3D representation based on the obtained location of the one or more canals; create a virtual drill guide based on (i) properties of the one or more placed virtual burs, (ii) properties of the virtual dental dam clamp and (iii) anatomies of one or more virtual teeth; wherein the virtual drill guide is designed such that the physical drill guide to be manufactured based on the virtual drill guide includes one or more physical holes based on the location of the placed virtual burs, and such that the one or more physical holes are configured to receive physical burs at a predetermined angle and position in order (i) allow the creation of an access opening to one or more physical canals in one or more physical teeth and (ii) to provide direction in the establishment of canal patency in the one or more physical teeth.

In another aspect herein, the system may further comprise one or more combinations of the following: (i) wherein the processor is further configured to manufacture the physical drill guide based on the virtual drill guide, (ii) wherein the one or more virtual burs are placed by rotating and translating them such that a cutting end of the one or more virtual burs are is placed at a canal orifice, (iii) wherein the virtual drill guide is automatically designed.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein and wherein:

FIG. 2A is a high level block diagram of a system according to an embodiment of the present invention.

FIG. 1B is a flowchart showing an exemplary method according to an embodiment of the present invention

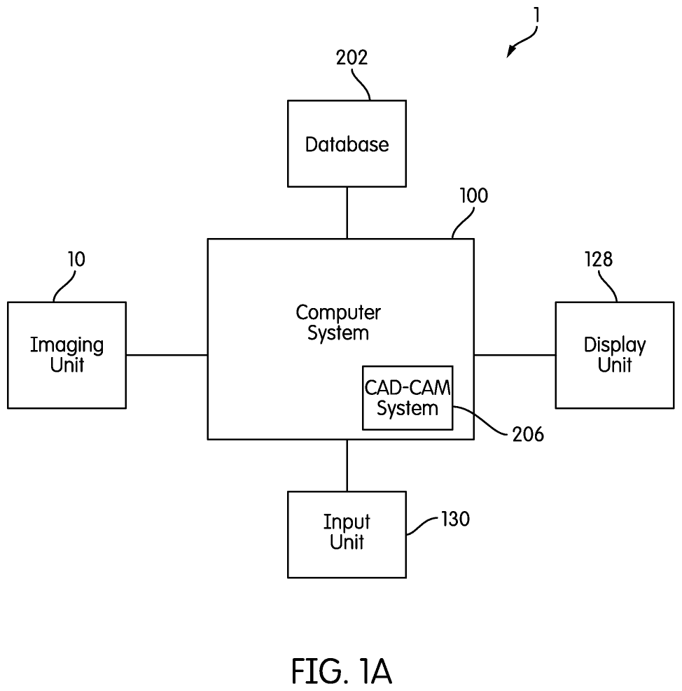

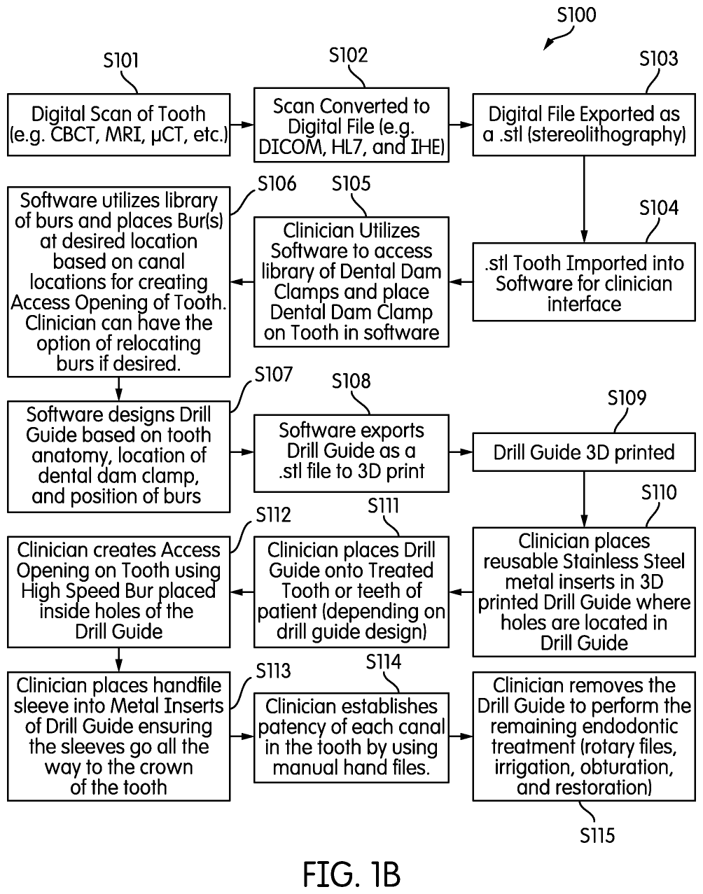

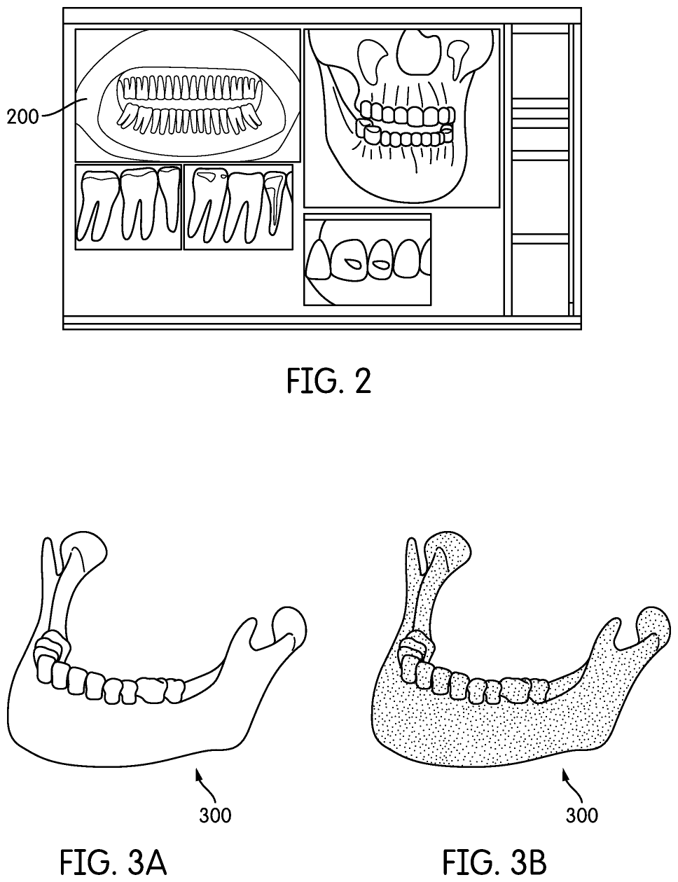

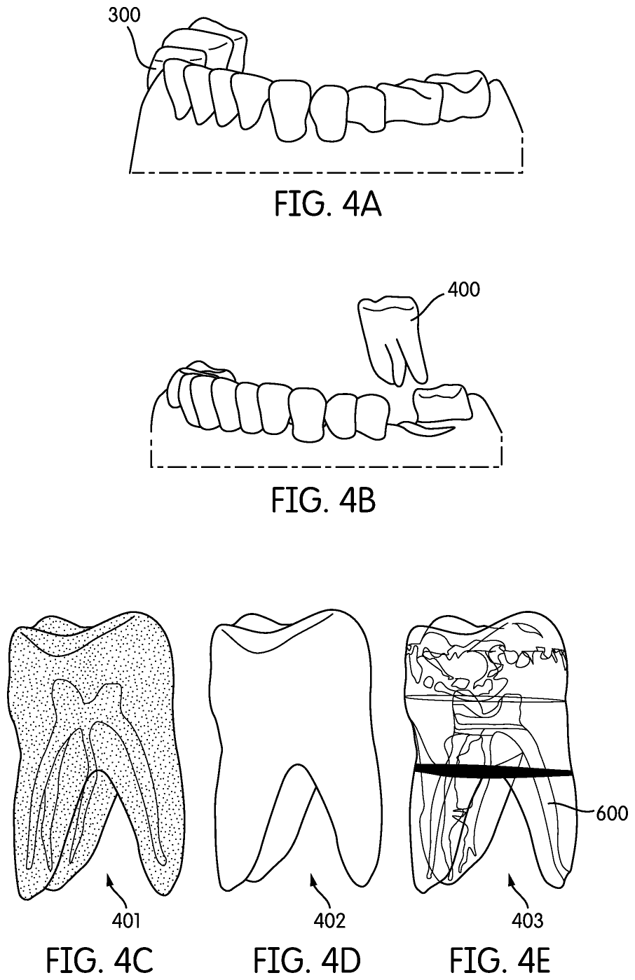

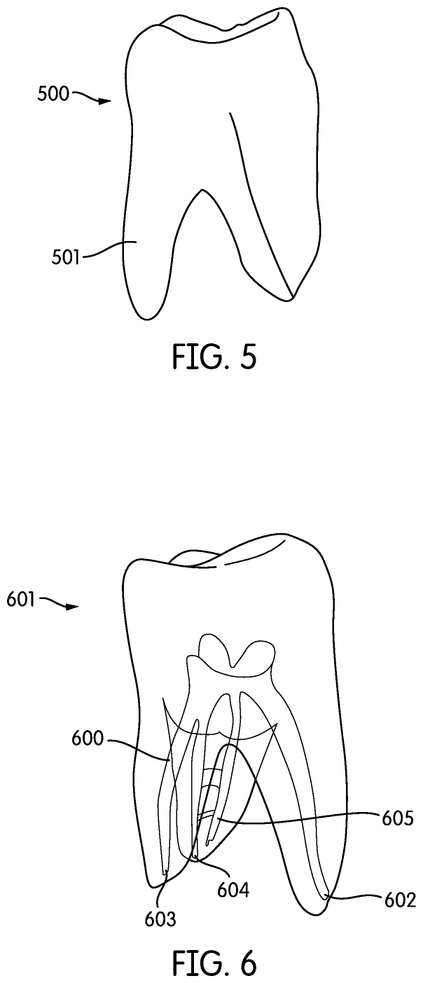

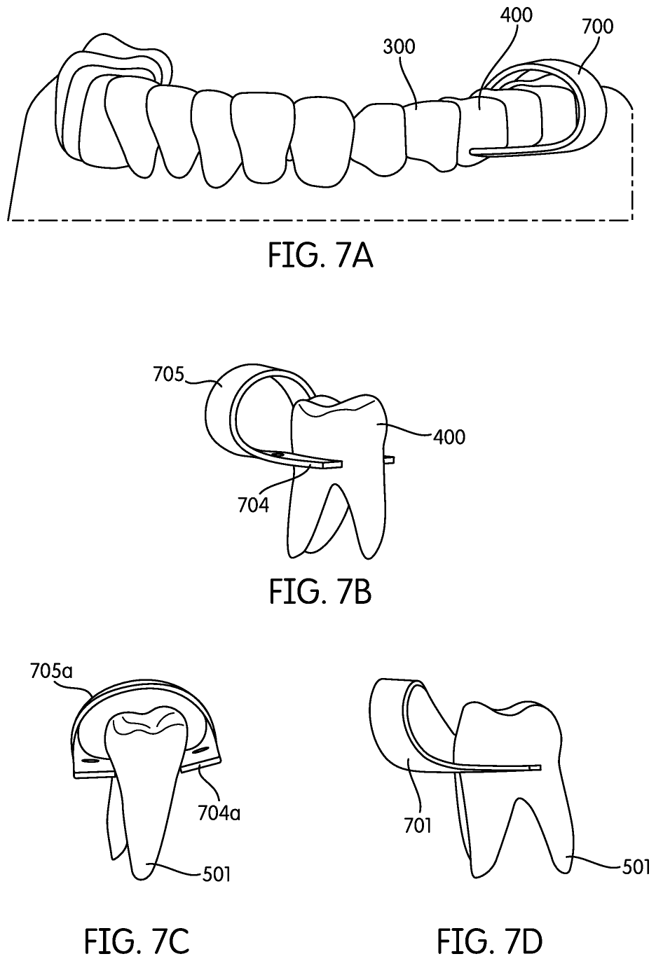

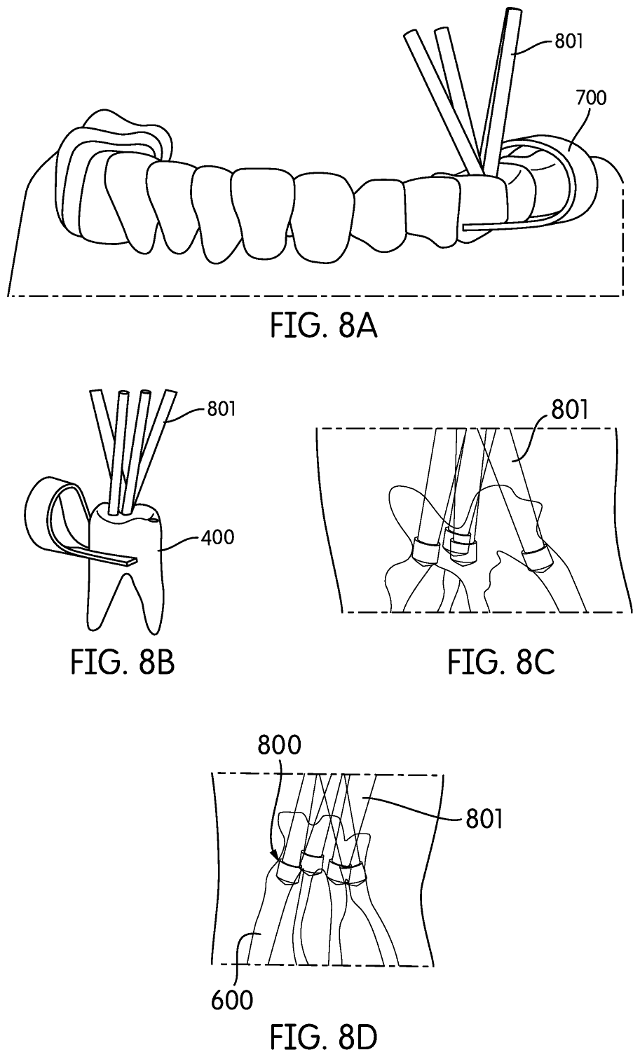

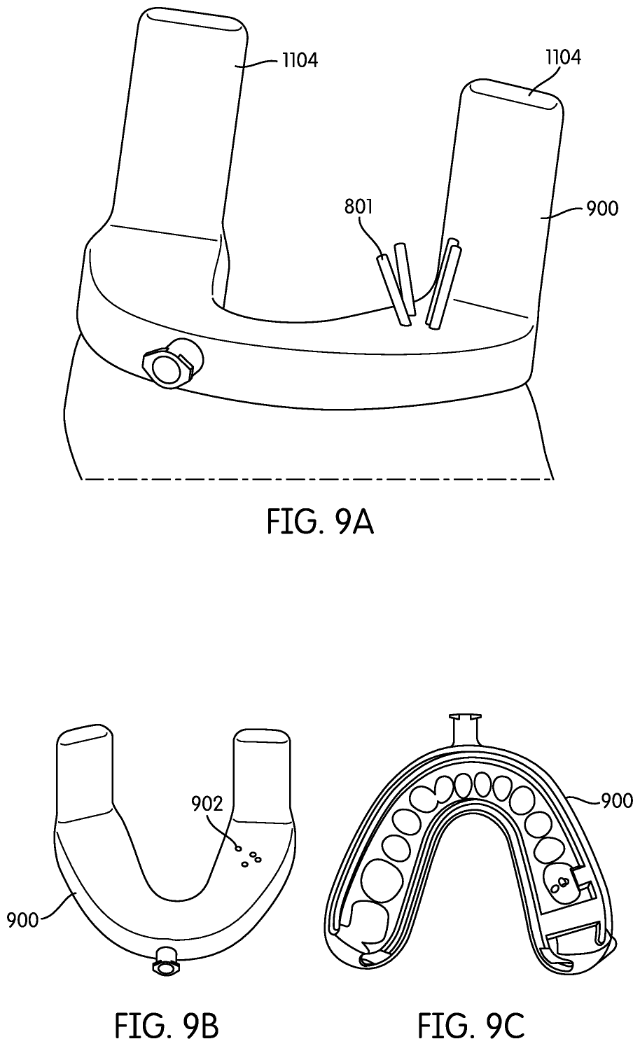

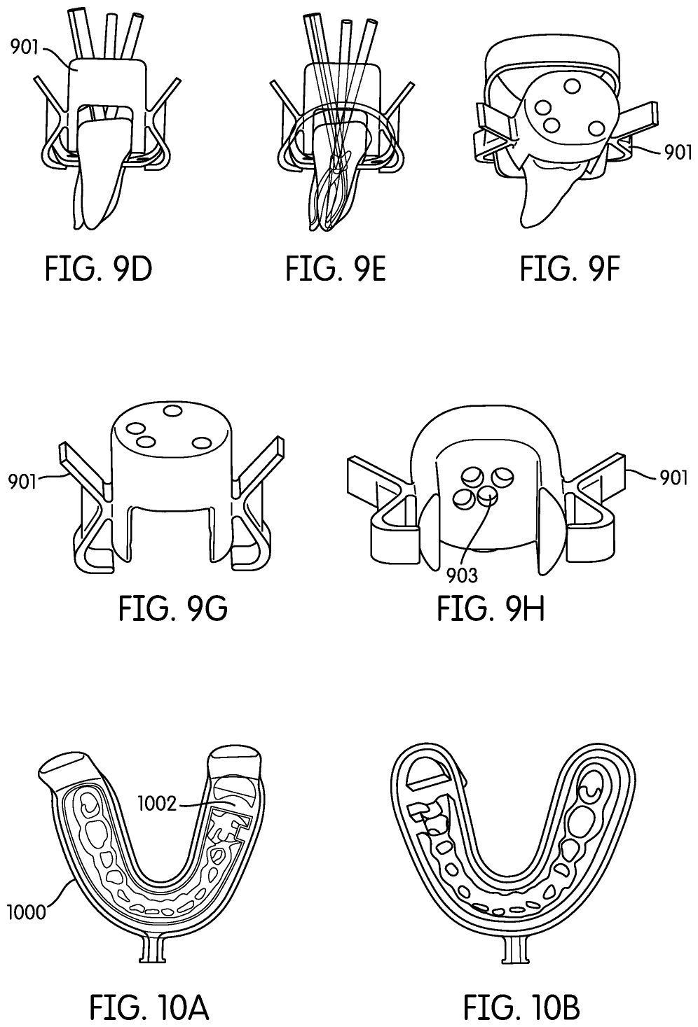

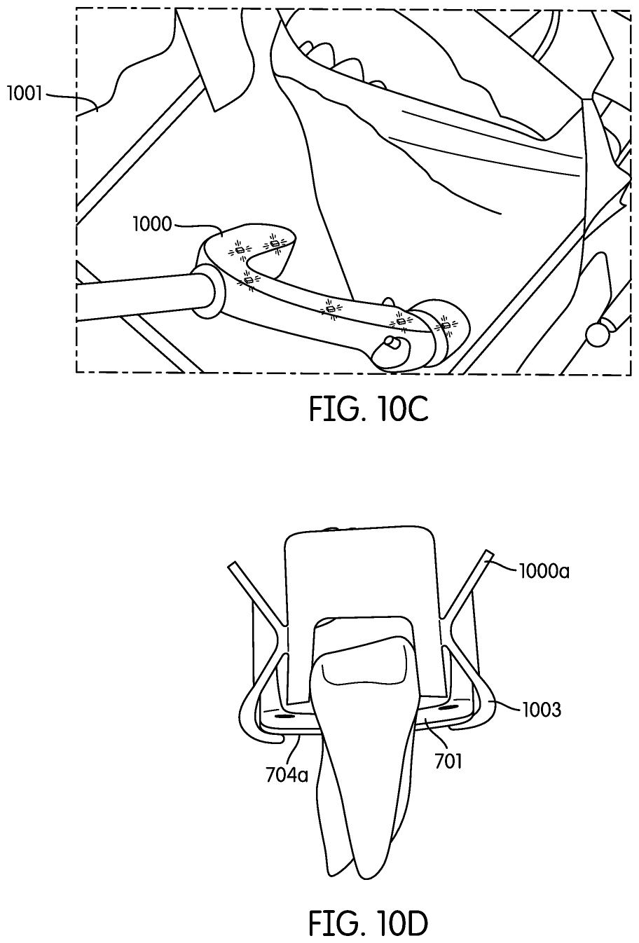

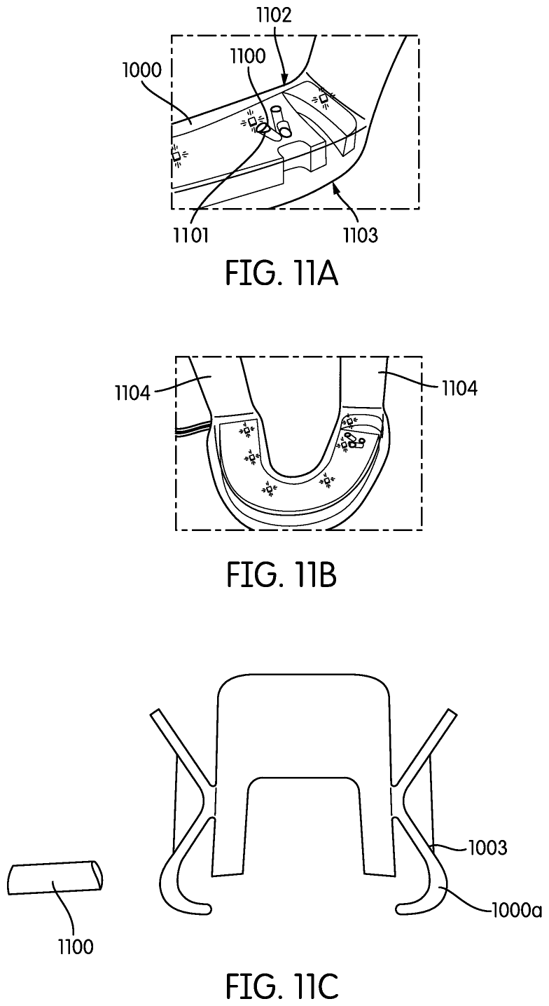

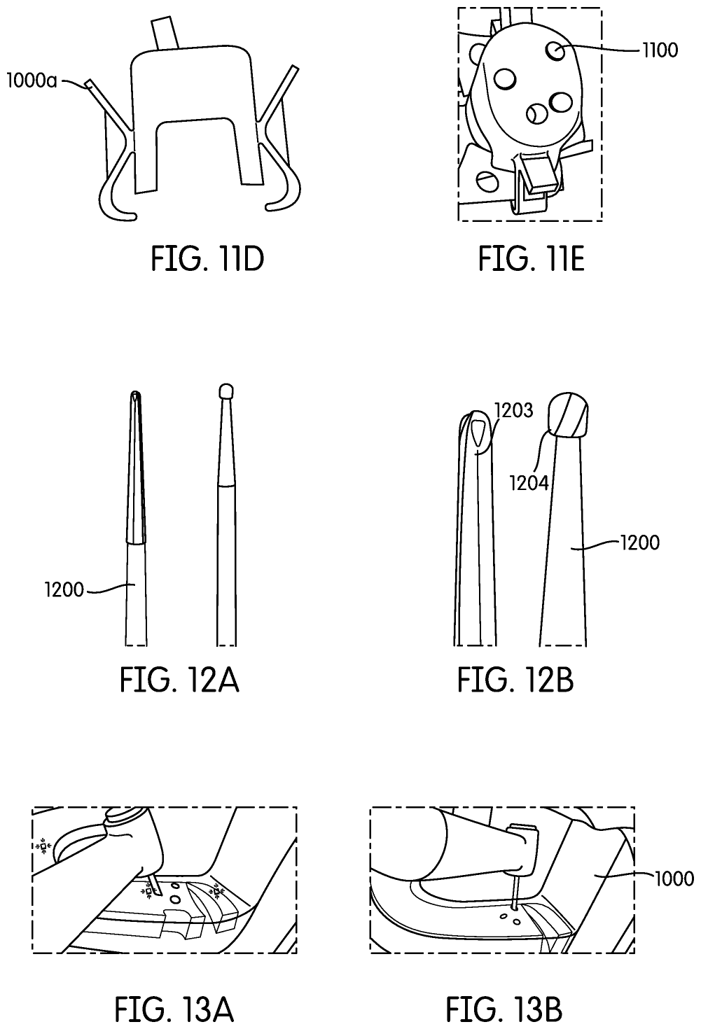

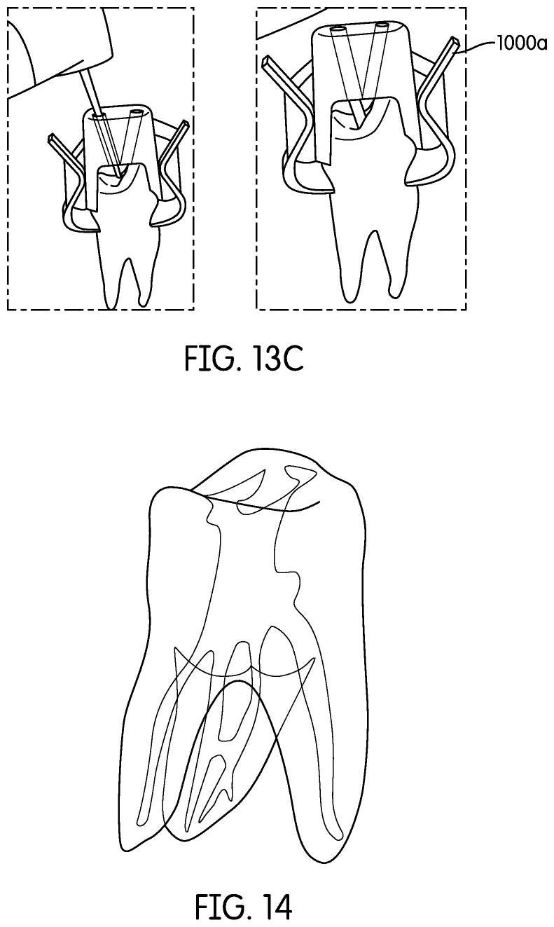

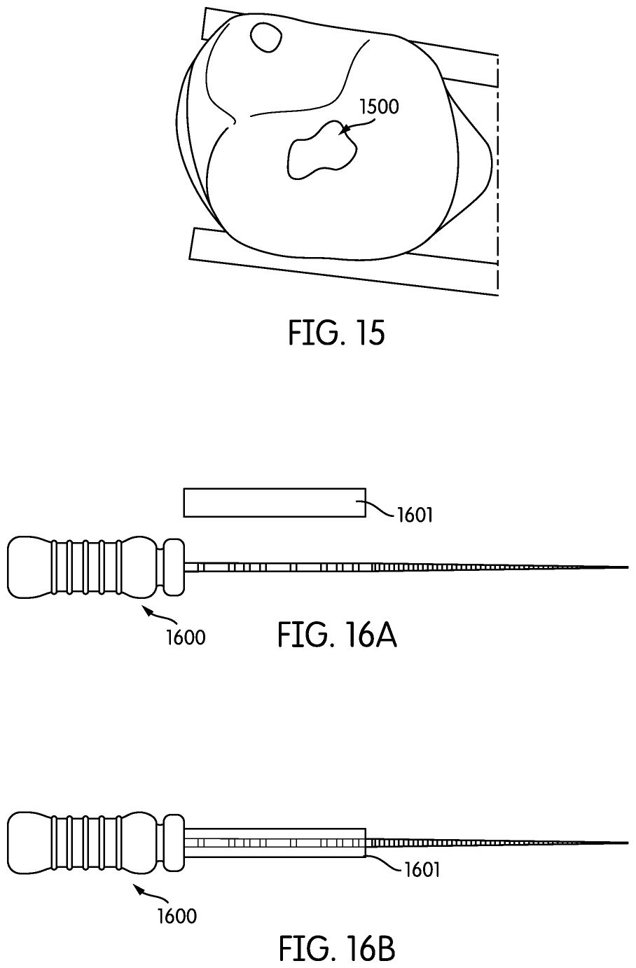

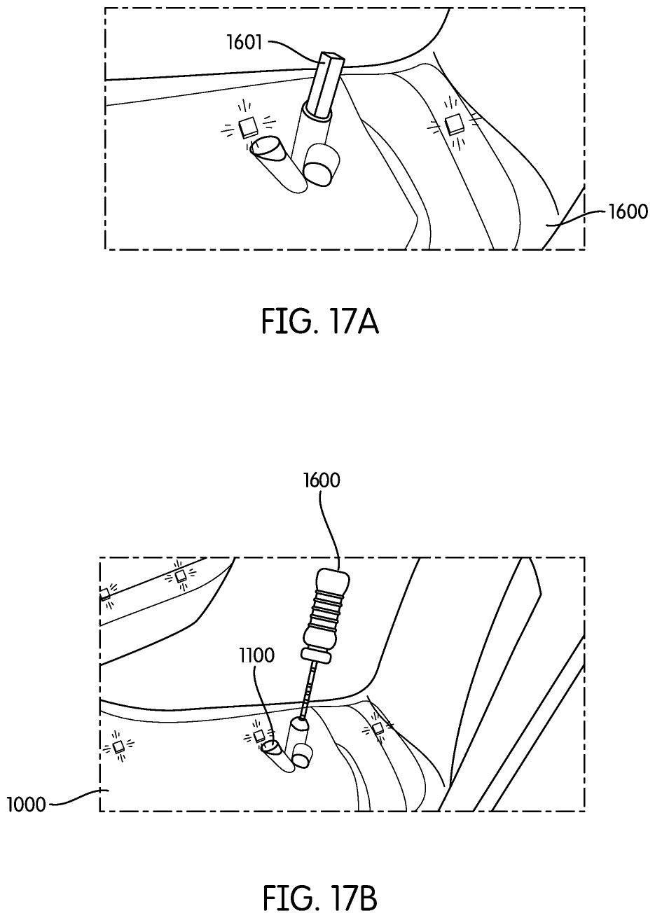

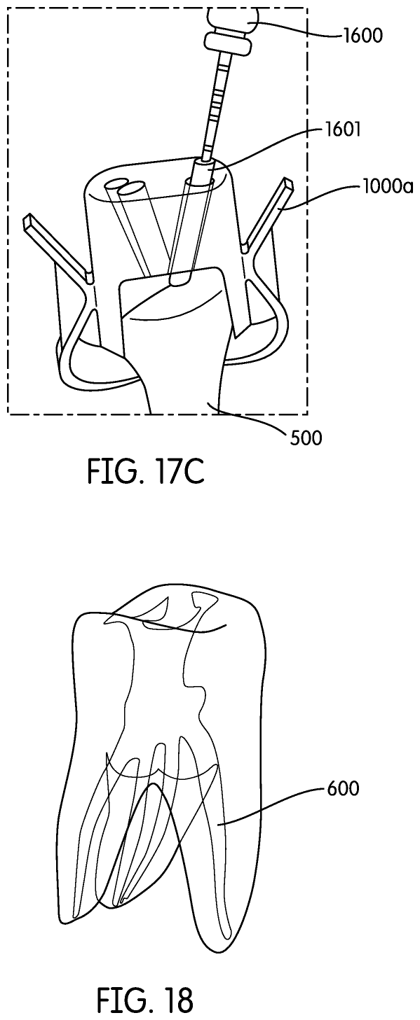

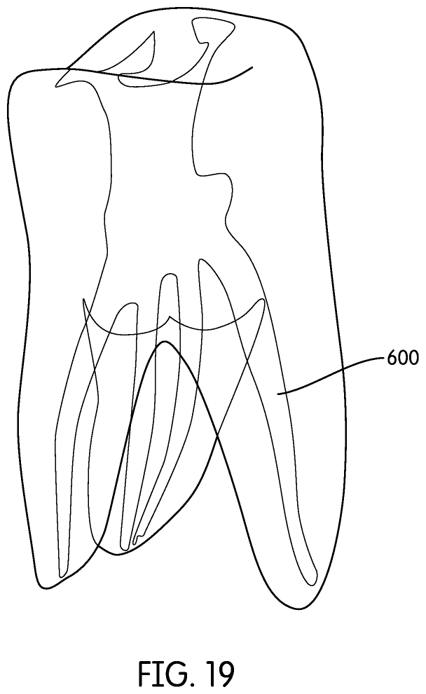

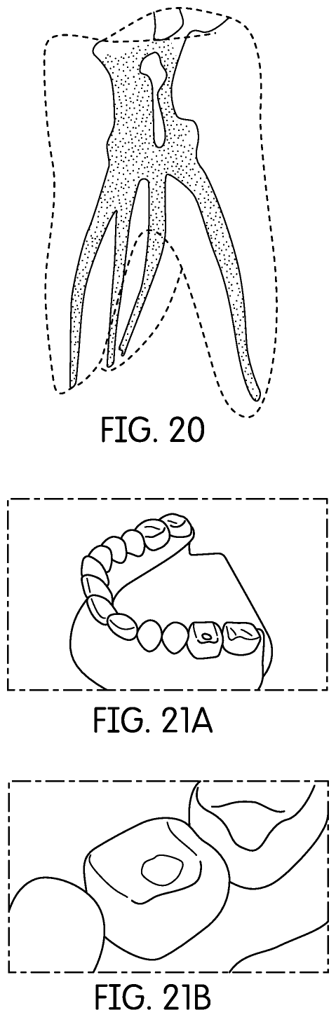

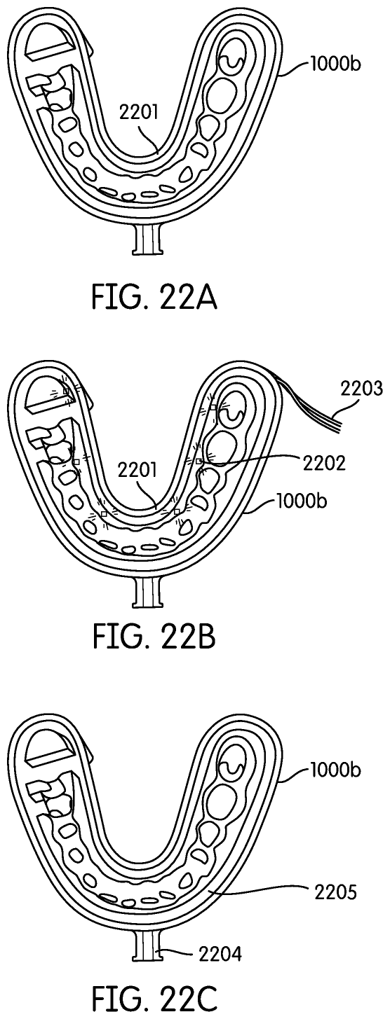

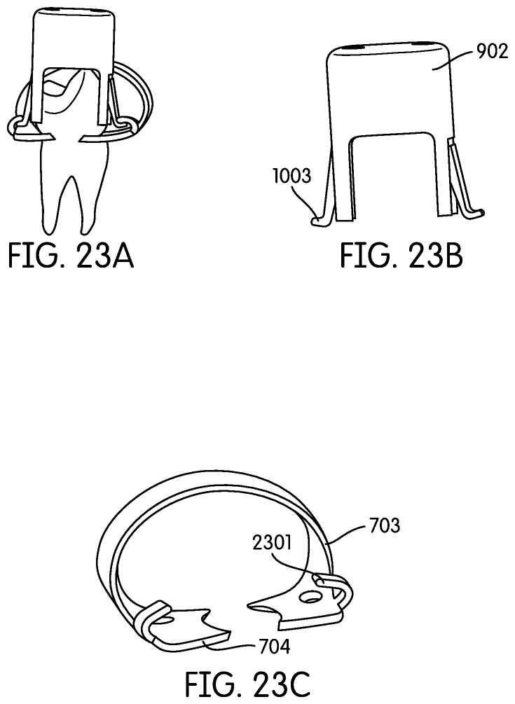

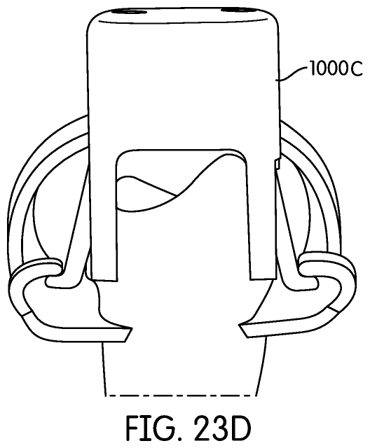

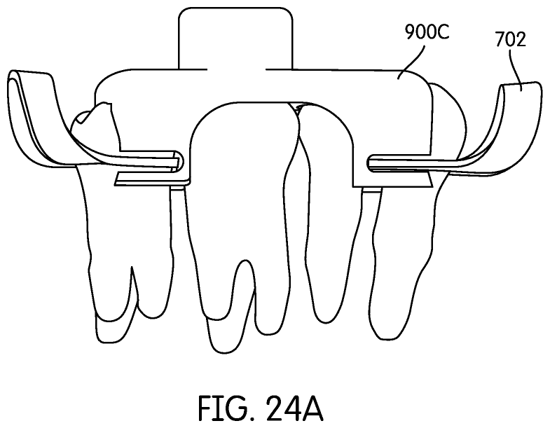

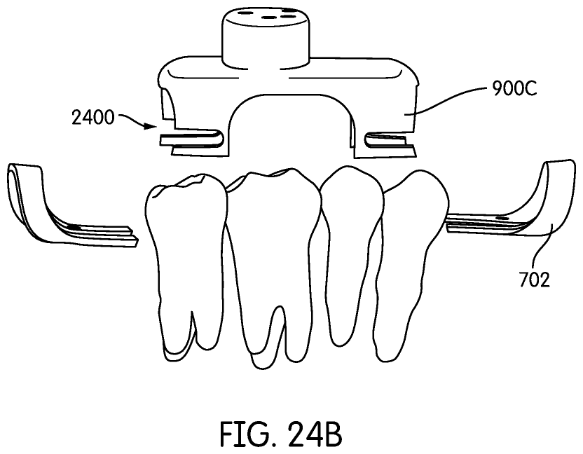

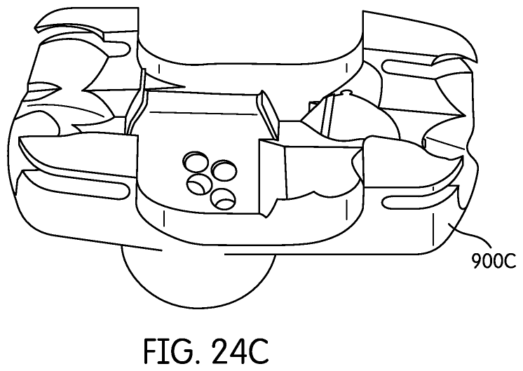

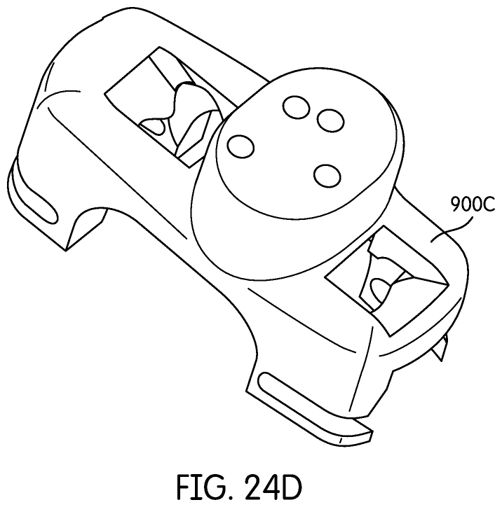

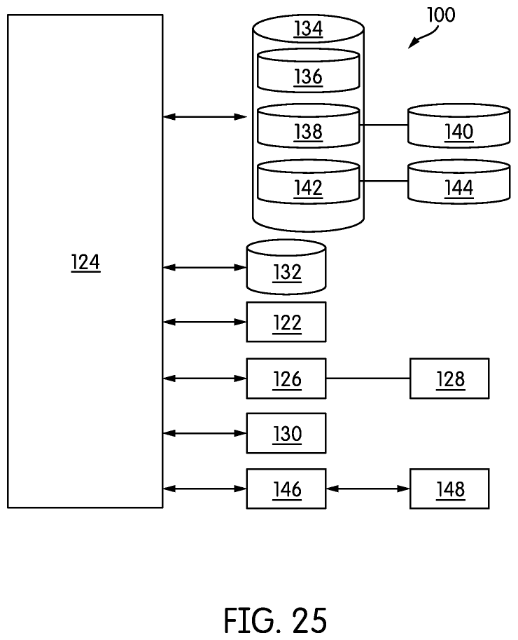

FIG. 2 is a diagram of a 3D scan (e.g. CBCT) of a tooth to be treated.

FIG. 3A is a perspective view of a model/digital 3D representation of a CBCT scan according to an embodiment of the present invention.

FIG. 3B is a perspective view of a model/digital 3D representation of a CBCT scan according to another embodiment of the present invention.

FIG. 4A is a perspective view of a 3D model illustrating the identification of a tooth to be treated.

FIG. 4B is another perspective view of the 3D model illustrating the identification of a tooth to be treated.

FIG. 4C is a perspective view of an identified tooth to be treated according to an embodiment of the present invention.

FIG. 4D is a perspective view of an identified tooth to be treated according to another embodiment of the present invention.

FIG. 4E is a perspective view of an identified tooth to be treated according to another embodiment of the present invention.

FIG. 5 shows a perspective view of a physical tooth.

FIG. 6 shows a μCT Scan of a tooth.

FIG. 7A shows a perspective view of a 3D model showing a dental dam clamp placed on tooth of in 3D model.

FIG. 7B shows a perspective view of a 3D model showing a dental dam clamp placed on tooth.

FIG. 7C shows a perspective view of a physical tooth showing a dental dam clamp placed on tooth.

FIG. 7D shows another perspective view of FIG. 7C.

FIG. 8A is a perspective view of a 3D model illustrating bur orientation according to an exemplary embodiment of the present invention.

FIG. 8B is a perspective view of a 3D model illustrating bur orientation according to another exemplary embodiment of the present invention.

FIG. 8C is a perspective view of a 3D model illustrating bur orientation according to another exemplary embodiment of the present invention.

FIG. 8D is a perspective view of a 3D model illustrating bur orientation according to another exemplary embodiment of the present invention.

FIG. 9A is a perspective view showing a virtual 3D guide according to an exemplary embodiment of the present invention.

FIG. 9B is a perspective view showing a virtual 3D guide according to an exemplary embodiment of the present invention.

FIG. 9C is another perspective view showing a virtual 3D guide according to an exemplary embodiment of the present invention.

FIG. 9D is a perspective view showing another virtual 3D guide according to another exemplary embodiment of the present invention.

FIG. 9E is a perspective view showing a virtual 3D guide according to an exemplary embodiment of the present invention.

FIG. 9F is another perspective view showing another virtual 3D guide according to an exemplary embodiment of the present invention.

FIG. 9G is another perspective view showing another virtual 3D guide according to an exemplary embodiment of the present invention.

FIG. 9H is another perspective view showing another virtual 3D guide according to another exemplary embodiment of the present invention.

FIG. 10A is a perspective view illustrating a custom drill guide according to an embodiment of the present invention.

FIG. 10B is a perspective view illustrating a custom drill guide according to an embodiment of the present invention.

FIG. 10C is a perspective view illustrating a custom drill guide according to an embodiment of the present invention.

FIG. 10D is a perspective view illustrating a custom drill guide according to an embodiment of the present invention.

FIG. 11A is a perspective view illustrating reusable metal inserts.

FIG. 11B is another perspective view illustrating reusable metal inserts.

FIG. 11C is another front view illustrating reusable metal inserts.

FIG. 11D is another front view illustrating reusable metal inserts.

FIG. 11E is a perceptive view illustrating reusable metal inserts.

FIG. 12A is a front view illustrating high speed burs.

FIG. 12B is another front view illustrating high speed burs.

FIG. 13A is a sketch showing the creation of access openings in teeth.

FIG. 13B is another sketch showing the creation of access openings in teeth.

FIG. 13C is another sketch showing the creation of access openings in teeth.

FIG. 14 is a front view showing a CT scan of a tooth after creating an access opening.

FIG. 15 is a top view of a tooth with an access opening.

FIG. 16A is a side view illustrating a handfile and a guide for the handfile.

FIG. 16B is another side view illustrating a handfile and a guide for the handfile.

FIG. 17A is a sketch illustrating a process of using a handfile with a drill guide.

FIG. 17B is another sketch illustrating a process of using a handfile with a drill guide.

FIG. 17C is another sketch illustrating a process of using a handfile with a drill guide.

FIG. 18 is a diagram showing a CT scan of a tooth after creating patency.

FIG. 19 is a diagram showing a CT scan of a tooth after shaping.

FIG. 20 is a diagram showing a CT scan of a tooth after obturation.

FIG. 21 is a perspective view showing an obturated tooth obturated in place.

FIG. 22A is a perspective view of an alternative embodiment of the present invention.

FIG. 22B is another perspective view of an alternative embodiment of the present invention.

FIG. 22C is another perspective view of an alternative embodiment of the present invention.

FIG. 23A is a perspective view of an alternative embodiment of the present invention.

FIG. 23B is another perspective view of an alternative embodiment of the present invention.

FIG. 23C is another perspective view of an alternative embodiment of the present invention.

FIG. 23D is another perspective view of an alternative embodiment of the present invention.

FIG. 24A is a perspective view of yet another alternative embodiment of the present invention.

FIG. 24B is a perspective view of yet another alternative embodiment of the present invention.

FIG. 24C is a perspective view of yet another alternative embodiment of the present invention.

FIG. 24D is a perspective view of yet another alternative embodiment of the present invention.

FIG. 25 is a block diagram of a computer system according to an exemplary embodiment of the present invention.

Different ones of the figures may have at least some reference numerals that may be the same in order to identify the same components, although a detailed description of each such component may not be provided below with respect to each Figure.

### DETAILED DESCRIPTION OF THE INVENTION

In accordance with example aspects described herein, a method, a system and computer readable storage media for creating a physical drill guide for the purpose of providing reduced access openings while providing direction in establishing canal patency within an endodontically treated tooth. The invention also relates to the physical drill guide.

System and Method for Producing a Custom Drill Guide

The invention proposes a system 1 as shown in FIG. 1A for producing a custom drill guide 1000 (FIG. 10A). The custom drill guide may be a physical drill guide that is manufactured, using for example, subtractive manufacturing such as milling, grinding etc. as well as additive manufacturing such as 3D printing or any other method of converting a virtual design into a physical form. More specifically, it may be manufactured using CAD/CAM system 206 of the computer system 100. In an embodiment, aid CAD/CAM System 206 may also include a software for some or all of the designing processes discussed hereinafter. In another embodiment, the software may be separate from the CAD/CAM System 206. The system 1 may include an imaging unit 10 which may be connected to or separate from a computer system 100. The imaging unit 10 of the system 1 may be any device used for creating a digital scan 200 of a tooth such as a Cone Beam Computed Tomography (CBCT) device, a Micro-Computed Tomography (pCT) device, a Magnetic Resonance Imaging (MRI) device and/or the like. The system 1 may also include a database 202 containing a library of burs 1200, a library of dental dam clamps, a library of handfiles, and/or otherwise database of accessories for creating an access and/or pathway within a tooth, a display unit 128 and/or an input unit 130. The database 202, input unit 130 and display unit 128 may be a part of the computer system 100 or may be separate from the computer system 100. In an embodiment, the system 1 may allow the creation/design of burs, dental dam clamps and handfiles.

The computer system 100, in conjunction with the input unit 130, database 202 and display unit 128 may be used to design and create a custom/physical drill guide 1000 for the purpose of providing access openings 1500 while providing direction in establishing canal patency within an endodontically treated tooth. Furthermore, the computer system 100 may be used to place and orientate accessories to be used with the custom drill guide 1000 in order to ensure effectiveness when using burs 1200 (such as high speed burs) in creating access openings 1500 and handfiles 1600 in creating canal patency. In some embodiments, provisions for lighting and integrated suction may be designed into the custom drill guide 1000.

FIG. 1B shows a process S100 in accordance with at least some of the embodiments herein. The process S100 may be used to generate a custom drill guide 1000 for the purpose of creating an access opening 1500 (FIG. 15) in the crown of the physical tooth 500 (FIG. 5) and specifically for locating each canal 600 (FIG. 6) in the tooth and furthermore for creating patency via handfiles 1600 within each canal 600 to working length.

In this process, as illustrated by Step S101 of FIG. 1B, a clinician may scan a patient's teeth/mouth to obtain a 3D scan/image. This scan may be conducted in an area of interest in the mouth where root canal therapy is to occur. The 3D scan may be conducted using a variety of imaging technologies that may include CBCT, MRI, pCT and/or otherwise imaging technologies in order to create a digital characterization of the tooth or set of teeth and convert the digital characterization of the tooth or set of teeth into a format such as DICOM, HL7, IHE, etc., Step S102. The 3D scan may be such that the root canals are located as part of the scan. Herein, they may be located in relationship to the crown of the treated tooth.

Once the digital creation of the area of interest (e.g. tooth for root canal therapy) is obtained, the computer system 100 may be used to convert the digital scan 200 into a model/digital 3D representation 300 (having a format such as stereolithograph; .stl or 3D point cloud; .xyz or the like), Step S103, that may be imported into an interface, Step S104, and used in creating a virtual drill guide 900 specific to the corresponding location of the canals 600 of the physical tooth 500 that will be receiving the root canal therapy.

Herein, a clinician may utilize the computer system 100 to access a library of virtual dental dam clamps 700. The virtual tooth 400 may be identified and a virtual dental dam clamp 700 may be placed and oriented on this virtual tooth 400 corresponding to the physical tooth 500 that will receive the root canal therapy, Step S105, as a corresponding physical dental clamp 701 would be placed for the root canal procedure. The placement may also be manually modified by the clinician. The physical dental dam clamp 701 corresponding to the virtual dental dam clamp 700 may be used to hold the dental dam 1001 in place on teeth and may also be used to fixate the drill guide onto the teeth as well.

A database 202 containing a library of virtual burs 801 may then be accessed to place virtual bur(s) 801 in a manner (such as position, angulation and the like) such that the virtual burs 801 are orientated at the orifice(s) 800 of each canal 600 within the virtual tooth 400, Step S106. Herein, the treated tooth may be “interrogated” to identify the root canals within the tooth. This may be based on a density or gray scale differences between the tooth (dentin, enamel, etc.) and the canals (void space). Locations of the virtual burs 801 may then be recommended by placing the virtual burs 801 at the orifice locations of the canals 600. The software may have the recommended locations of the virtual burs 801 to position and angulate said virtual burs 801 such that they are optimized for minimal access opening 1500 while preventing (or substantially preventing) the virtual burs 801 from interfering with each other. After the virtual burs 801 are placed in their recommended positions/angulations, the clinician may optionally reorient the virtual burs 801 by translations and rotation in or about the X, Y, and Z axes.

Once the virtual bur(s) 801 and the virtual dental dam clamp 700 locations are established, the computer system may create a design of the drill guide (virtual drill guide 900) that incorporates the properties of these components/accessories (properties such as shape, size, orientation, and position of the virtual burs 801, virtual dental dam clamp 700 and surrounding tooth anatomies), so that the properties of these corresponding physical components/accessories are taken into account relative to the properties (e.g., size, shape, orientation, etc.) of a custom drill guide 1000, when designed and manufactured, Step S107. Herein, once the virtual burs 801 and virtual dental and/or dam clamp 700 are positioned on the virtual tooth. The virtual drill guide 900 may be designed by an algorithm where it creates a fixture design around the treated tooth designed to match and fixate around the crown of the treated tooth and then designs the fixture to fixate to the dental dam clamp. The holes are then created in the fixture by subtracting the volume of the burs into the fixture.

After the virtual drill guide design has been designed, a digital output file (such as a stereolithograpy file; .stl) may be exported, Step S108 for use in creating/manufacturing a custom drill guide 1000 in Step S109. Once the drill guide has been manufactured or 3D printed, the clinician may place metal sleeves/inserts 1100 (FIG. 11A) within the holes of the drill guide, Step S110. The sleeves may be placed such that they are prevented from rotating and moving while creating the access opening. To ensure this, the sleeves may be designed to have an anti-rotating feature such as a key way or flat that matches holes in the drill guide and may also have a ring or stop at the top to keep it from going down further. To prevent the sleeve from coming up, it may have a compressible clip that engages at the bottom of the drill. A person of ordinary skill in the art will recognize in light of this specification that other design may be employed to achieve similar results. This may prevent the high speed burs which may be rotating at over 2000 RPM from contacting the custom drill guide 1000. If the burs contact the custom drill guide 1000, a material of said custom drill guide may melt, distort, etc. due to a high speed friction of the bur 1200 in contact with the 3D printed material. These metal inserts 1100 may be reusable via sterilization (steam autoclave) of the inserts after each procedure or they can be replaced/disposable.

Once the custom drill guide 1000 has the metal inserts placed inside of it, the root canal therapy procedure may begin. Herein, the clinician may place a physical dental dam clamp 701 corresponding to the virtual dental clamp 700 in conjunction with a dental dam 1001 on the patient's tooth or teeth to be treated, Step S111, with the physical dental clamp 701 being placed and orientated the same way as how the virtual dental clamp 700 was positioned/located in a software of the computer system 100. The clinician may then place the custom drill guide on the tooth that will receive the root canal therapy.

As shown in Step S112, once the custom drill guide is placed and/or secured, the clinician may use a bur 1200 such as a high speed bur to create access openings 1500 to an orifice 800 of each canal 600 within the physical tooth 500. Once the access opening(s) 1500 is/are created at each canal orifice 800, the clinician may use manual stainless steel handfiles for the purpose of establishing patency for each canal within the tooth. Herein patency may be considered as a canal preparation technique in which an apical portion of the canal is maintained free of debris by recapitulation with a small file through the apical foramen. In using the handfiles, the clinician can place a handfile sleeve 1601 inside the metal insert 1100 of the custom drill guide 1000. The handfile sleeve 1601 may be placed within the metal insert of the drill guide such that the handfile sleeve 1601 contacts the crown of the tooth, Step S113. In one embodiment, the handfile sleeve 1601 is reusable. In another embodiment, the handfile sleeve 1601 is disposable.

In the next step, Step S114, the clinician may establish patency in each canal of the tooth by using hand files. Because the clinician may use an apex locator during the process of establishing patency within each canal while using the handfile 1600, the handfile sleeve 1601 is preferably not made from an electrically conductive material since the apex locator uses an electric circuitry concept in the determination of a working length of each canal. A metal handfile sleeve may cause a short circuit or inaccurate readings from an apex locator. The material the handfile sleeve 1601 may be made from steam autoclavable plastic material such as Polyphenylsufone (Radel), Polyetherimide (Ultem), Polyether ether ketone (PEEK), etc. or disposable produced from a 3D printable material.

The purpose of the handfile sleeve 1601 may be to allow the handfile 1600 to remain centered within the holes of the drill guide in order to prevent the location of the handfile from deviating from the canal orifice. Once the clinician establishes canal patency for each canal up to a predetermined handfile size (#10, #15, etc.), the clinician is ready to proceed with the mechanized file process of the procedure. The clinician may then remove the custom drill guide 1000 from the patient for the mechanized shaping, irrigation, and obturation process as the location of the canals and openings of the canals have been established, Step S115.

In an alternative embodiment of the present invention, one or more teeth may be separated/segmented from the rest of the model/digital 3D representation 300 such that a user/clinician may plan or design the virtual drill guide 900 in isolation prior to production of the custom drill guide 1000. That way the placement of virtual burs 801 may be visualized more clearly in order to design the virtual drill guide 900.

In another alternative embodiment, accessories for use in a treatment procedure such as the dental dam clamp, burs, handfile sleeve, metal inserts, handfile and the like may be individually designed in the software based on dimensions of the digital 3D representation 300 for manufacturing.

Custom Drill Guide

The custom drill guide 1000 and the process S100 of creating the custom drill guide 1000 will now be described in more detail with reference FIGS. 2-21 as well FIG. 1B. Any or all of the steps described may be performed automatically by the computer system, manually by a clinician or any combinations thereof.

As shown in FIG. 11A, the custom drill guide 1000 may include one or more holes 1101 each beginning at a first surface 1102 and running through a body of the physical drill guide to a second surface 1103 opposite the first surface 1102. The custom drill guide 1000 may be dimensioned to accommodate one or more physical burs, one or more dental dam clamps and to fit on one or more teeth as described herein. The dimensions of the one or more holes 1101 may be configured to receive the physical burs at a predetermined angle and position in order to (i) allow the creation of an access opening to one or more physical canals and (ii) to provide direction in the establishment of canal patency in the treated tooth. The physical dental dam clamp 701 corresponding to the virtual dental dam clamp 700 may be used to hold the dental dam 1001 in place and may also be used to fixate the custom drill guide 1000 onto teeth as well. This may be achieved during the design phase through the presence of virtual arms 704 and virtual head 705 on the virtual dental dam clamp 700 that are dimensioned to be affixed to one or more teeth. Space occupied by the virtual dental dam clamp 700 may be taken into consideration when creating the virtual drill guide 900 such as by subtracting said space from the virtual drill guide 900. The virtual drill guide 900 may be designed to engage the portions of the virtual dental dam clamp 700 such as the virtual arms or head so that corresponding custom drill guide 1000 is tightly secured on one or more teeth during treatment (such as procedures with high speed burs) without moving. Various forms of engagement between the custom drill guide 1000 and the head 705a or arms 704a or any other part of the physical dental dam clamp 701 are achievable. For example, in FIGS. 10A-B, a head slot 1002 in the custom drill guide 1000 may be dimensioned to receive a head 705a of a physical dental dam clamp 701 in order to secure the custom drill guide 1000 on the teeth. In FIG. 10D, the extension 1003 of the custom drill guide 1000 may be dimensioned to engage the arms 704a of the physical dental dam clamp 701.

Using, tooth 500 (FIG. 5) such as a mandibular molar 501, a scan of which is shown in FIG. 6, having 4 canals including a Palatal 602, Distal (distobuccal) 603, Mesial Buccal 1 604 and Mesial Buccal 2 605 canals the custom drill guide and process will be described further.

FIG. 2 shows an example of the output provided when performing a scan such as a CBCT (cone beam computed tomography) scan of the patient. This digital scan 200 may be converted into a model/digital 3D representation 300 such as a 3D representation of the mandible as shown in FIG. 3A. Said model/digital 3D representation 300 may be, for example, in an stl format as shown in FIG. 3A or in a point cloud format as shown in FIG. 3B or the like.

FIGS. 4A-4E show the mandibular molar 501 identified in different forms. Specifically, FIG. 4A-4B show a model/digital 3D representation 300 of the mandible, said model/digital 3D representation 300 includes a virtual tooth 400 which represents the mandibular molar 501. A digital image output mesh file 401, 402 (in a stereolithography, point cloud, format or the like etc.) such as is shown in FIGS. 4C-4D may be imported into a software of the computer system 100 wherein the software may also display a modified virtual form of the tooth 403 (FIG. 4E) and the canals 600 within the tooth. Canals may be seen in the point cloud and .stl formats. These may also be converted into a solid modeling format as well such as STEP, IGES, etc. as well to see the canals without obstruction.

In an exemplary embodiment as shown in FIG. 6, a MicroCT image 601 (or other image such as a CBCT image, MRI image or the like) of the mandibular molar 501 may show where the internal canal morphology may be located in relationship with the outer tooth anatomy.

As shown in FIG. 7 in order to create the virtual drill guide 900 that may be used in manufacturing the custom drill guide 1000 a virtual dental dam clamp 700 may be placed (such as manually or automatically) on the virtual tooth 400 as shown in FIG. 7A and FIG. 7B. The placement may be performed to match or substantially match the placement of a corresponding physical dental clamp 701 on the mandibular molar 501 (FIG. 7C-7D). FIGS. 7A-7D show a comparison of the placement of a dental clamp in software versus the actual placement of the corresponding physical dental dam clamp 701 relative to a physical tooth 500 (the mandibular molar 501).

FIG. 8A shows that once the virtual dental dam clamp 700 has been placed onto the tooth, virtual burs 801 may be selected from a library and each of them may be automatically placed by the software based on a predefined algorithm and/or furthermore can be placed (through, for example, rotating and translating them in the X, Y, and Z planes) by the user where a cutting end of the virtual bur 801 may be positioned at each canal orifice 800 (FIGS. 8C-8D) of the tooth and may be oriented to minimize the size of the access opening 1500. More specifically, the access opening 1500 may be the space removed from the crown of the tooth in order to allow the clinician to locate and place handfiles and dental drills into the orifices of the root canals. The objective may be to create an access opening or access openings 1500 that are large enough to provide for the location and placement of the handfiles and dental drills to the orifices of the root canals but not so large that material is unnecessarily removed from the crown of the tooth.

Once the location and orientation of the virtual burs 801 have been determined a virtual drill guide 900 may be created. This may be achieved, for example, by taking into consideration dimensions of the patient's oral cavity and allowing for a necessary material thickness for the drill guide and height requirements for the top of the drill guide to allow for a patient's mouth to open and still allow for burs, handfiles, and drills to go Into the drill guide, i.e. properties of the one or more placed virtual burs, properties of the virtual dental dam clamp and/or anatomies of one or more virtual teeth may be taken into consideration to create the virtual drill guide 900.

This virtual drill guide 900 may be designed using an Input unit 130 and a display unit 128. FIGS. 9A-9H shows examples of the design of the virtual drill guide 900. FIGS. 9A-9C show a virtual drill guide 900 that may be seated on, for example, a lower jaw of a patient and FIGS. 9D-9H show the design of another virtual drill guide that may be seated on a single tooth, such as a mandibular molar of a patient. In an embodiment, the design of the virtual drill guides 900, 901 may be automatic and may take into account the location of the virtual burs 801 and the virtual dental dam clamp 700 to ensure that the produced custom drill guide 1000 will fixate (though removable) onto the physical tooth or teeth and have the holes 1101 (FIG. 11A) within (and extending therethrough) the drill guide in a correct orientation relative to the direct physical burs. In an exemplary embodiment, the holes in the virtual drill guide 900 (where the virtual burs 801 are located) may be created by subtracting the space where the burs are located (i.e. removal of volume between the virtual drill guide 900 and virtual burs 801). Moreover, space needed for the location of the dental dam clamp may be subtracted from the virtual drill guide 900. Of course, other ways of creating the virtual drill guide will be recognized after reading this specification.

Once the drill guide design is completed the design of the drill guide may be exported into a format (e.g. stereolithography) that is capable of being sent/communicated for manufacturing/production.

FIGS. 10A-10D, as well as FIGS. 9A-9C and 11A, show examples of the custom drill guide 1000, 1000a and how they are affixed to the patient's tooth/teeth. For instance, as shown in FIG. 10D, there are two extensions 1003 on each side of the custom drill guide 1000a that fit around the arms 704a of the physical dental dam clamp 701. In FIG. 11B, there are 2 other extensions 1104 from the back of the custom drill guide 1000 where the patient's jaw may set down on and hold said custom drill guide 1000 down. In place. FIG. 9 also shows these 2 other extensions 1104.

After the manufacturing, metal sleeves 1100 may be placed into the holes 1101, in the drill guide, corresponding to the virtual holes 903 to prevent the high speed dental bur from contacting the custom drill guides 1000, 1000a as shown in FIG. 11A-11E, which show different views of the printed guide. Contact of the high speed bur with the drill guide may cause the holes in the guide to melt, distort, etc.

FIGS. 12 A-B shows example burs 1200 that may be used with the present invention. FIG. 12B shows a magnified view of FIG. 12A, illustrating a multi-purpose tapered end cutting bur 1203 and a round side cutting bur 1204. In a preferred embodiment herein, a structure of the bur 1200 used combines features from each bur of FIGS. 12A-12B. The bur may be a tapered end cutting bur 1203 with a reduced length of the taper as shown in 1204. The reason an end cutting bur may be used for this application may be because during advancement of the bur into and/or within the drill guide, the end of the bur may be penetrating and cutting into the hard enamel of the tooth crown. A side cutting bur may not be able to achieve the efficient cutting of the crown when being used with the drill guide. The taper of the bur 1200 may need to be as small as possible, so that the bur 1200 may remain centered within the metal insert 1100 in the drill guide. If the bur is tapered where the taper is longer or as long as the metal insert in the drill guide, it may become more difficult for the bur to remain centered within the hole of the drill guide. For example, if only the tapered portion of the bur is inside of the metal insert in the drill guide, the bur may go off center from the drill guide and may also be angulated relative to the center of the hole in the drill guide. This will then create an access opening in the tooth that is not in alignment with the root canal in the tooth.

Once the corresponding physical dental dam clamp 701 has been placed on the physical tooth/teeth 500, the custom drill guide 1000, 1000a may be placed as shown in FIGS. 13A-13C and then the clinician can proceed in advancing the high speed bur inside of the drill guide to create the access openings 1500 within the tooth to the orifice 800 of the canals.

FIG. 14 shows a pCT scans of the mandibular molar 501 after the access openings 1500 are created within the tooth.

In FIG. 15, a top view of the crown of the mandibular molar 501 showing the size of the access opening 1500 created. Once the access openings 1500 have been created with the high speed bur to locate each canal 600 in the tooth, the clinician may use handfiles 1600 such as manual stainless steel handfiles to create a path in each canal 600 to allow mechanized files to be used to shape the canal 600. In order to use the handfiles 1600 with the custom drill guide 1000, handfile sleeves 1601 may be utilized to help maintain the centering of the handfile to the orifice opening of the canal. FIG. 16 A-B shows the handfile sleeve 1601 and how it fits onto the handfile 1600. The handfile sleeve 1601 may be made from a sterilizable, steam autoclavable material for reuse or from a disposable plastic such as 3D printed material. The material of the handfile sleeve is preferably not electrically conductive in order that apex locators can still be used in conjunction with the handfile when the clinician is establishing canal patency and working length for each canal. Herein, the clinician may place the handfile sleeve into the metal insert 1100 located within the custom drill guide 1000 such that the handfile sleeve 1601 makes contact with the crown of the tooth. The clinician may then advance the handfile 1600 into the handfile sleeve 1601 which will allow the handfile 1600 to be centered and enter into the orifice of the canal as shown in FIGS. 17A-C.

FIG. 18 shows a pCT of the mandibular molar 501 where each canal has been created patent up to a #15 Size K-File using the custom drill guide 1000 with handfile sleeve 1601. Once the canals 600 have been opened up to a predetermined size defined by the clinician using the handfiles 1600, the clinician may remove the drill guide from the tooth/teeth. The remaining processes of using mechanized files, irrigation, and obturation may be performed without the use of the custom drill guide 1000.

FIG. 19 shows a pCT of the mandibular molar 501 which was scanned after each canal 600 was shaped up to a 25.07 variable tapered size. The mandibular molar 501 was then irrigated using NaOCI and EDTA ultrasonically activated. After irrigation the mandibular molar 501 was obturated using a Single Cone Obturation Technique using Sealer and GuttaPercha points matching the file shape.

FIG. 20 shows the pCT scan of the mandibular molar 501 after obturation and FIG. 21A-B show the mandibular molar 501 in the patient's mouth after obturation.

Turning now to FIGS. 22-23, further embodiments of the present invention will be discussed. As shown in FIGS. 22A-C, the custom drill guide 1000b may have a channel 2201 for light integration such as for receiving a light source 2202, such as an LED light source, or a connection to a light source in order to illuminate the mouth during treatment. The custom drill guide may also have a connection 2203 (such as insulated cables or wires) to a power source (not shown). The connection 2203 and the power source that may be preferably housed in the custom drill guide 1000b in one embodiment. In another embodiment as shown in FIG. 22C the custom drill guide 1000b may have a connector 2204 for connection to a suction system (not shown) and a channel for suction integration 2205 to remove liquid or debris from the patient's mouth during treatment.

FIGS. 23A-D show yet another embodiment of the custom drill guide 1000c. In these figures, a design of a second virtual drill guide 902 is shown along with another virtual dental clamp 703. Herein, a specific dental dam clamp may engage the second virtual drill guide 902. The specific dental dam clamp may be designed and manufactured specifically to accommodate and attach to a custom drill guide 1000c. The virtual arms 704 on the second virtual dental dam clamp 703 may engage the extensions 1003 on the second virtual drill guide 902 through the U-shaped tabs 2301. The extensions 1003 on the custom drill guide 1000c may be compressible and may be compressed when being placed on the clamp and then released to hold the custom drill guide 1000c onto the clamp. This may make it easier to place the custom drill guide 1000c on the tooth and clamp.

In FIGS. 24 A-D, a third virtual drill guide 900c which may be manufactured into another custom drill guide is shown. The figures show various perspective views of the guide. The third virtual dental dam clamp 702 corresponding to the third virtual drill guide 900c may be designed to fit into the aperture 2400 of the third virtual drill guide 900c in order to keep the third virtual drill guide 900c on the teeth during treatment. Herein, multiple teeth may be clamped on using a plurality of similar or different virtual dental dam clamps 702 as shown in FIGS. 24 A-B. In this alternative embodiment, dental dam clamp(s) may be placed on teeth adjacent to the tooth to be treated instead of on the said tooth to be treated. This may provide more flexibility to the clinician in ensuring that the orientation of the fixture is correct in relationship with the tooth to be treated.

It will be understood by a person of ordinary skill in the art, in light of this description that other methods, processes and embodiments may be implemented in light of the descriptions provided.

Computer System for Producing a Drill Guide

Having described the process S100 of FIG. 1B reference will now be made to FIG. 25, which shows a block diagram of a computer system 100 that may be employed in accordance with at least some of the example embodiments herein. Although various embodiments may be described herein in terms of this exemplary computer system 100, after reading this description, it may become apparent to a person skilled in the relevant art(s) how to implement the invention using other computer systems and/or architectures.

The computer system 100 may include or be separate from a CAD/CAM System 206 that may be used in designing and/or manufacturing the drill guide. The computer system may also include at least one computer processor 122, user interface 126 and input unit 130. The input unit 130 in one exemplary embodiment may be used by the dentist/clinician along with a display unit 128 such as a monitor to design the virtual drill guide 900 for manufacturing. In another exemplary embodiment herein, the input unit 130 is a finger or stylus to be used on a touchscreen interface display device (not shown). The input unit 130 may alternatively be a gesture recognition device, a trackball, a mouse or other input device such as a keyboard or stylus. In one example, the display unit 128, the input unit 130, and the computer processor 122 may collectively form the user interface 126.

The computer processor 122 may include, for example, a central processing unit, a multiple processing unit, an application-specific Integrated circuit (“ASIC”), a field programmable gate array (“FPGA”), or the like. The processor 122 may be connected to a communication infrastructure 124 (e.g., a communications bus, or a network). In an embodiment herein, the processor 122 may receive a request for creating a virtual drill guide 900 and may automatically create or allow the creation of the virtual drill guide 900 using the CAD/CAM System 206 and the database 202. The processor 122 may achieve this by loading corresponding instructions stored in a non-transitory storage device in the form of computer-readable program instructions and executing the loaded instructions.

The computer system 100 may further comprise a main memory 132, which may be a random access memory (“RAM”) and also may include a secondary memory 134. The secondary memory 134 may include, for example, a hard disk drive 136 and/or a removable-storage drive 138. The removable-storage drive 138 may read from and/or write to a removable storage unit 140 in a well-known manner. The removable storage unit 140 may be, for example, a floppy disk, a magnetic tape, an optical disk, a flash memory device, and the like, which may be written to and read from by the removable-storage drive 138. The removable storage unit 140 may include a non-transitory computer-readable storage medium storing computer-executable software instructions and/or data.

In further alternative embodiments, the secondary memory 134 may include other computer-readable media storing computer-executable programs or other instructions to be loaded into the computer system 100. Such devices may include a removable storage unit 144 and an interface 142 (e.g., a program cartridge and a cartridge interface); a removable memory chip (e.g., an erasable programmable read-only memory (“EPROM”) or a programmable read-only memory (“PROM”)) and an associated memory socket; and other removable storage units 144 and interfaces 142 that allow software and data to be transferred from the removable storage unit 144 to other parts of the computer system 100.

The computer system 100 also may include a communications interface 146 that enables software and data to be transferred between the computer system 100 and external devices. Such an interface may include a modem, a network interface (e.g., an Ethernet card, a wireless interface, a cloud delivering hosted services over the internet, etc.), a communications port (e.g., a Universal Serial Bus (“USB”) port or a FireWire® port), a Personal Computer Memory Card International Association (“PCMCIA”) interface, Bluetooth®, and the like. Software and data transferred via the communications interface 146 may be in the form of signals, which may be electronic, electromagnetic, optical or another type of signal that may be capable of being transmitted and/or received by the communications interface 146. Signals may be provided to the communications interface 146 via a communications path 148 (e.g., a channel). The communications path 148 may carry signals and may be implemented using wire or cable, fiber optics, a telephone line, a cellular link, a radio-frequency (“RF”) link, or the like. The communications interface 146 may be used to transfer software or data or other information between the computer system 100 and a remote server or cloud-based storage.

One or more computer programs or computer control logic may be stored in the main memory 132 and/or the secondary memory 134. The computer programs may also be received via the communications interface 146. The computer programs may include computer-executable instructions which, when executed by the computer processor 122, cause the computer system 100 to perform some or all of the methods described herein.

In another embodiment, the software may be stored in a non-transitory computer-readable storage medium and loaded into the main memory 132 and/or the secondary memory 134 of the computer system 100 using the removable-storage drive 138, the hard disk drive 136, and/or the communications interface 146.

Implementation of other hardware and software arrangements so as to perform the functions described herein will be apparent to persons skilled in the relevant art(s) in view of this description.

What is claimed is:

1. A method for creating a virtual drill guide for manufacturing a physical drill guide, said method comprising:
obtaining a digital 3D representation of one or more physical teeth;
obtaining a location of one or more canals in the digital 3D representation;
placing a virtual dental dam clamp in the digital 3D representation based on a desired location and/or orientation of a corresponding physical dental dam clamp;
placing one or more virtual burs in the digital 3D representation based on the obtained location of the one or more canals;
creating a virtual drill guide based on (i) at least one property of the one or more placed virtual burs, (ii) at least one property of the virtual dental dam clamp and/or (iii) an anatomy of one or more virtual teeth;
wherein the virtual drill guide is designed such that the physical drill guide to be manufactured corresponds to the virtual drill guide;
wherein the physical drill guide includes one or more physical holes, each physical hole being configured to receive a physical bur at a predetermined angle and position in order (i) to allow the creation of an access opening to one or more physical canals in the one or more physical teeth and/or (ii) to provide guidance in the establishment of canal patency in the one or more physical teeth; and
wherein the one or more physical holes are based on the location of the placed virtual burs, respectively, of the virtual drill guide.

2. The method according to claim 1, further comprising:
manufacturing the physical drill guide based on the virtual drill guide.

3. The method according to claim 2, further comprising:
placing metal inserts in the one or more physical holes and creating an access opening on the one or more physical teeth using a bur placed inside the metal insert of the physical drill guide.

4. The method according to claim 3, further comprising placing a handfile sleeve into the metal insert until contact is made with a crown of the one or more physical teeth and establishing canal patency in the one or more physical teeth using a handfile.

5. The method according to claim 1, wherein the properties of the one or more placed virtual burs and the at least one property of the dental dam clamp are selected from one or more properties including shape, size, orientation, and position.

6. The method according to claim 1, wherein one or more virtual teeth are segmented from the digital 3D representation to allow for isolated designing of the virtual drill guide.

7. The method according to claim 1, wherein the one or more virtual burs are placed by rotating and translating them such that a cutting end of the one or more virtual burs are is placed at a canal orifice.

8. The method according to claim 1, wherein the virtual drill guide is configured to be seated on a single tooth or a plurality of adjacent teeth.

9. The method according to claim 1, wherein the virtual drill guide is automatically designed.

10. The method according to claim 1, wherein the virtual drill guide is configured using at least input from a user.

11. The method according to claim 1, wherein the virtual drill guide includes a channel for receiving a light source.

12. The method according to claim 1, wherein the virtual drill guide includes a connector for connection to a suction system.

13. The method according to claim 1, wherein the virtual drill guide is configured to accommodate a plurality of virtual dental dam clamps.

14. A method for creating a physical drill guide for endodontic use, said method comprising:
obtaining a digital 3D representation of one or more physical teeth;
obtaining a location of one or more canals in the digital 3D representation;
placing a virtual dental dam clamp in the digital 3D representation based on a desired location and/or orientation of a corresponding physical dental dam clamp;
placing one or more virtual burs in the digital 3D representation based on the obtained location of the one or more canals;
creating a virtual drill guide based on (i) at least one property of the one or more placed virtual burs, (ii) at least one property of the virtual dental dam clamp, and/or (iii) an anatomy of one or more virtual teeth;
fabricating the physical drill guide using the virtual drill guide.

15. A custom drill guide comprising:
one or more holes each beginning at a first surface and running through a body of the custom drill guide to a second surface opposite the first surface; and
wherein the drill guide is dimensioned to accommodate one or more physical burs, one or more dental dam clamps and to fit on one or more teeth;
wherein the dimensions of the one or more holes are configured to receive the physical bur, respectively, at a predetermined angle and position in order (i) to allow the creation of an access opening to one or more physical canals in one or more physical teeth and/or (ii) to provide guidance in the establishment of canal patency in the one or more physical teeth.

16. The custom drill guide of claim 15, wherein the custom drill guide is dimensioned to engage one or more parts of the one or more dental dam clamps in order to secure the custom drill guide onto the one or more teeth.

17. The custom drill guide of claim 16, wherein the custom drill guide includes a slot that receives a head of the one or more dental dam clamps.

18. The custom drill guide of claim 16, wherein the custom drill guide includes an extension that engages arms of the one or more dental dam clamps.

19. The custom drill guide of claim 15, further comprising a connector configured to connect to a suction system in order to remove liquid and debris from a patient's oral cavity during treatment.

20. The custom drill guide of claim 15, further comprising a channel disposed the body of the custom drill and configured to house light for illuminating a patient's oral cavity during treatment.

21. A non-transitory computer-readable storage medium storing a program which, when executed by a computer system, causes the computer system to perform a procedure comprising:
obtaining a digital 3D representation of one or more physical teeth;
obtaining a location of one or more canals in the digital 3D representation;
placing one or more virtual burs in the digital 3D representation based on the obtained location of the one or more canals;
creating a virtual drill guide based on (i) at least one property of the one or more placed virtual burs, (ii) at least one property of a virtual dental dam clamp and/or (iii) an anatomy of one or more virtual teeth; and
designing the virtual drill guide such that the physical drill guide to be manufactured corresponds to the virtual drill guide;
wherein the physical drill guide includes one or more physical holes, each physical hole being configured to receive a physical bur at a predetermined angle and position in order (i) to allow the creation of an access opening to one or more physical canals in one or more physical teeth and/or (ii) to provide guidance in the establishment of canal patency in the one or more physical teeth
wherein the one or more physical holes are based on the location of the placed virtual burs, respectively, of the virtual drill guide.

22. A system for creating a virtual drill guide for manufacturing a physical drill guide, said system comprising a processor configured to:
obtain a digital 3D representation of one or more physical teeth;
obtain a location of one or more canals in the digital 3D representation;
place a virtual dental dam clamp in the digital 3D representation based on a desired location and/or orientation of a corresponding physical dental dam clamp;
place one or more virtual burs in the digital 3D representation based on the obtained location of the one or more canals;
create a virtual drill guide based on (i) one or more properties of the one or more placed virtual burs, (ii) one or more properties of the virtual dental dam clamp and (iii) an anatomy of one or more virtual teeth;
wherein the physical drill guide includes one or more physical holes, each physical hole being configured to receive a physical bur at a predetermined angle and position in order (i) to allow the creation of an access opening to one or more physical canals in one or more physical teeth and/or (ii) to provide guidance in the establishment of canal patency in the one or more physical teeth
wherein the one or more physical holes are based on the location of the placed virtual burs, respectively, of the virtual drill guide.

23. The system according to claim 22, wherein the processor is further configured to manufacture the physical drill guide based on the virtual drill guide.

24. The method according to claim 22, wherein the one or more virtual burs are placed by rotating and translating them such that a cutting end of the one or more virtual burs are is placed at a canal orifice.

25. The method according to claim 22, wherein the virtual drill guide is automatically designed.
